(19) United States
(12) Patent Application Publication
(10) Pub. No.: US 2025/0386268 A1
(43) Pub. Date: Dec. 18, 2025

(54) ASSOCIATION PROCEDURES FOR SEAMLESS ROAMING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/219,992

(22) Filed: May 27, 2025

Related U.S. Application Data
(60) Provisional application No. 63/659,272, filed on Jun. 12, 2024.

(51) Int. Cl. H04W 36/08; H04W 36/00

(52) U.S. Cl. CPC H04W 36/08; H04W 36/0033

(57) ABSTRACT

Methods and apparatuses for association procedures for seamless roaming in WLANs. A method performed by a station (STA) associated with a first access point (AP) includes determining to associate the STA with a second AP, and transmitting, to the second AP, an association request message for associating the STA with the second AP. The method includes receiving, from the second AP, a response message in response to the association request message, and switching from a channel of the first AP to a channel of the second AP based on the association request message.

### CROSS-REFERENCE TO RELATED APPLICATION(S) AND CLAIM OF PRIORITY

This application claims priority under 35 U.S.C. § 119 (e) to U.S. Provisional Patent Application No. 63/659,272, filed on Jun. 12, 2024, which is hereby incorporated by reference in its entirety.

### TECHNICAL FIELD

This disclosure relates generally to wireless communication, and more specifically to association procedures for seamless roaming in wireless local area networks (WLANs).

### BACKGROUND

Wireless Local Area Network (WLAN) technology allows devices to access the internet in the 2.4 GHz, 5GHz, 6GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for association procedures for seamless roaming in WLANs.

In one embodiment, a method performed by a station (STA) associated with a first access point (AP) includes determining to associate the STA with a second AP, and transmitting, to the second AP, an association request message for associating the STA with the second AP. The method includes receiving, from the second AP, a response message in response to the association request message, and switching from a channel of the first AP to a channel of the second AP based on the association request message.

In another embodiment, a second AP comprises a transceiver configured to: receive, from a station (STA) associated with a first AP, an association request message for associating the STA with the second AP; and transmit, to the STA, a response message in response to the association request message. The second AP further comprises a processor operably coupled with the transceiver. The processor is configured to determine a channel for communication with the STA.

In yet another embodiment, a STA associated with a first AP comprises a processor configured to determine to associate the STA with a second AP. The STA further comprises a processor and a transceiver operably coupled with the processor. The transceiver is configured to: transmit, to the second AP, an association request message for associating the STA with the second AP; and receive, from the second AP, a response message in response to the association request message. The processor is further configured to switch from a channel of the first AP to a channel of the second AP based on the association request message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example method for association performed by a STA when switching to a new AP according to embodiments of the present disclosure;

FIG. 6 illustrates an example method for association performed by an AP when switching to a new AP according to embodiments of the present disclosure;

FIG. 7 illustrates an example of an association procedure when switching to a new AP according to embodiments of the present disclosure;

FIG. 8 illustrates another example of an association procedure when switching to a new AP according to embodiments of the present disclosure;

FIG. 9 illustrates an example of yet another association procedure when switching to a new AP according to embodiments of the present disclosure; and

FIG. 10 illustrates an example method performed by a STA in a wireless communication system according to embodiments of the present disclosure.

### DETAILED DESCRIPTION

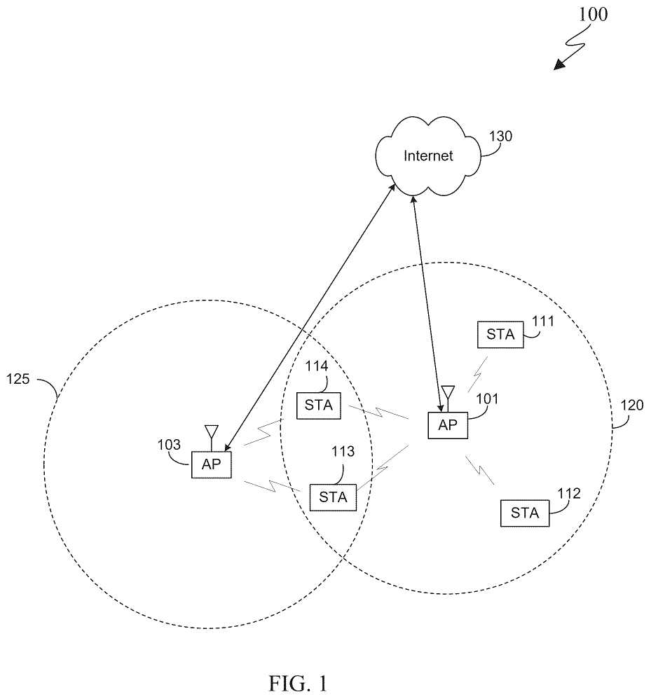

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023;[2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating association procedures for seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

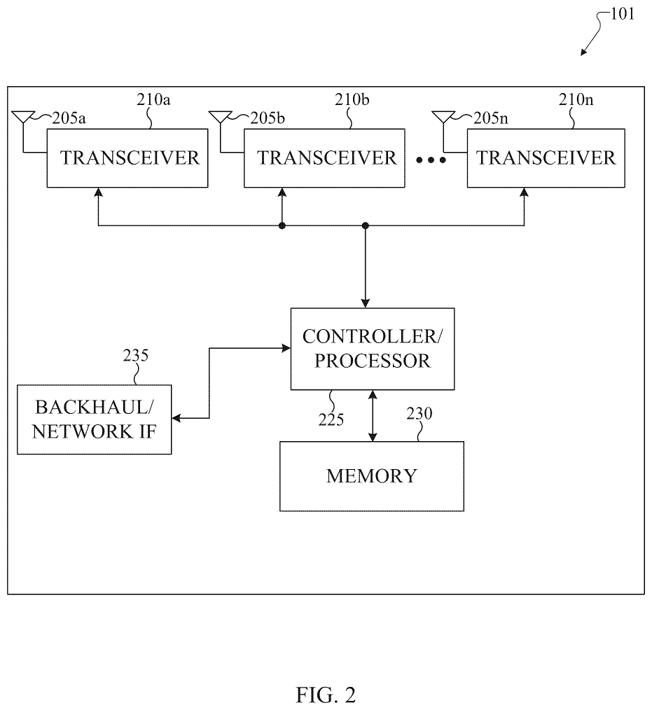

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighed differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating association procedures for seamless roaming in WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating association procedures for seamless roaming in WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

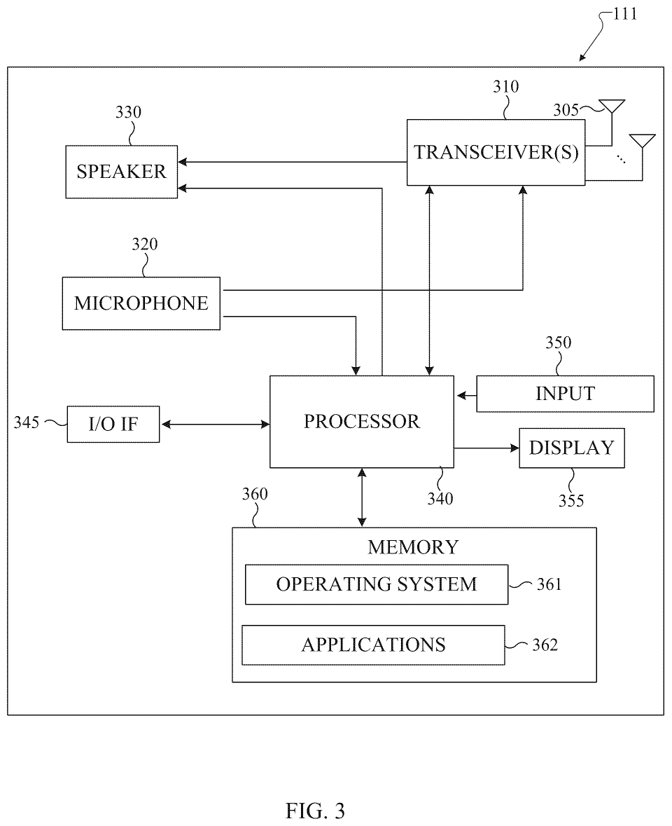

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate association procedures for seamless roaming in WLANs. In some embodiments, the processor 340 includes at least one microprocessor or microcontroller.

The processor 340 is also capable of executing other processes and programs resident in the memory 360, such as operations for facilitating association procedures for seamless roaming in WLANs. The processor 340 can move data into or out of the memory 360 as required by an executing process. In some embodiments, the processor 340 is configured to execute a plurality of applications 362, such as applications for facilitating association procedures for seamless roaming in WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

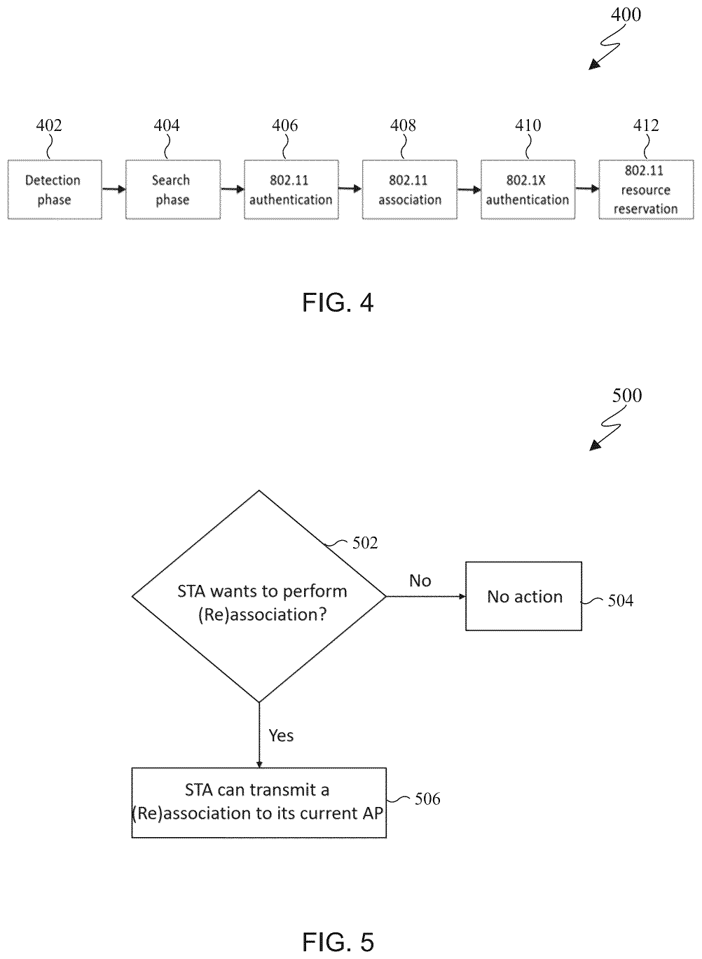

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in legacy devices without any mobility support, the handover procedure involves the following steps:

1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.

2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

3. 802.11 authentication: after the scanning procedure is complete, the next step is to perform 802.11 authentication 406 (open system/shared key based)), where the STA establishes its identity with the AP.

4. 802.11 association: Once the STA is authenticated, the next step is to perform association 408.

5. 802.1X authentication: Introduced in IEEE 802.1i amendment, the 802.1X authentication phase 410 comprises an EAP authentication between the STA and a AAA server with the assistance of the AP.

6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of MLO operation. This procedure helps to reduce the delays encountered due to 802.11 resource reservation 412 (step 6 above).

Embodiments of the present disclosure recognize that when a STA performs (Re)association during roaming, the STA needs to switch its channel. This can result in disruption of service with the current AP while the STA is on a different channel to perform (Re)association. The application performance can deteriorate. Procedures that can minimize or avoid such disruptions are needed.

Accordingly, embodiments of the present disclosure provide mechanisms for handling (Re)association procedures, including tunneled (Re)association, negotiation for (Re)association message usage, and capability advertisement.

### 1. Tunneled (Re)Association

According to some embodiments, a STA can transmit a (Re)association request message to the target AP via the current AP. According to this embodiment, the STA can transmit a request message containing at least one or more of the information items as indicated in Table 1.

TABLE 1
Information items in request message

| Information item | Description |
|---|---|
| Intended target AP | One or more information item(s) that can indicate |
| | the target AP(s) for which the frame is intended |
| | to be. E.g., target AP(s) SSID(s), BSSID(s), etc. |
| Legacy | One or more information item(s) that can be a |
| (Re)association | part of the legacy (Re)association |
| request message | request message. |
| content | |
| Tunnel intent | One or more information item(s) that can indicate |
| indication | that the STA can be requesting the current AP to |
| | transmit the (Re)association request message to |
| | the target AP(s). |
| Acknowledgement | One or more information item(s) that can indicate |
| (ACK) | that an ACK can be needed in response to the |
| requirement | request message from the current AP. |
| Switch upon ACK | One or more information item(s) that can indicate |
| | that the STA can switch to the target AP upon |
| | receiving the ACK and receive the (Re)association |
| | message from the target AP upon switching. |
| Duplicate | One or more information item(s) that can |
| response message | indicate that the STA can receive a |
| | duplicate (Re)association message from |
| | the target AP upon switching. |
| Indication upon | One or more information item(s) that can indicate |
| switching | that the STA can transmit an indication message |
| | upon switching to the target AP's channel. |

Upon receiving the above message, the current AP can generate an ACK message which can convey the reception of the above message. Additionally, the ACK message can also convey the current AP's intent to tunnel the message to the target AP.

The current AP can tunnel the message to the target AP over the wired network (e.g., over the distribution system (DS) communication). Upon receiving a response from the target AP, the current AP can also perform context transfer to the target AP. The context transfer can be a transfer of contexts related to block acknowledgement (BA), stream classification service (SCS), quality of service (QOS), target wake time (TWT) or its variants, serial number (SN), part number (PN), etc.

Upon receiving the response message from the target AP, the current AP can transmit the response message to the STA.

When the target AP receives a (Re)association request message that is tunneled to it via the current AP, the target AP can process the request and generate a (Re)association response message. The response message can be tunneled to the current AP over the wired network (e.g., over the DS).

Upon receiving the context transfer message from the current AP, the target AP can receive the context transfer and apply the context for the STA.

The (Re)association response message generated by the target AP can contain at least one or more of the information items as indicated in Table 2.

TABLE 2
Information items that can be present
in the (Re)association request message

| Information | |
|---|---|
| items | Description |
| Switching time | One or more information item(s) that can indicate the |
| indication | time by which the target AP can expect the STA to be |
| | present on its channel. E.g., number of TBTTs from |
| | the current TBTT relative to the current AP's beacons, |
| | a timestamp based on the current AP's TSF timer, etc. |
| Legacy response | One or more information item(s) that can belong to |
| message | the legacy (Re)association response message. |
| Context transfer | One or more information item(s) that can indicate |
| confirmation | that the context transfer has been successfully |
| indication | completed. |
| Context(s) for | One or more information item(s) that can indicate |
| which the | the context(s) for which the transfer has been |
| transfer is | successfully completed. For the remaining, the STA |
| successful | can be expected to perform a setup after |
| | switching. |

When the STA receives the (Re)association response message via its current AP, the STA can switch to the target AP's channel at the indicated time. The target AP can transmit a duplicate (Re)association response message to the STA after the STA has switched to the target AP's channel. Alternatively, the STA can also transmit a notification message after switching.

FIG. 5 illustrates an example method 500 for association performed by a STA when switching to a new AP according to embodiments of the present disclosure. For example, the method 500 for association performed by a STA when switching to a new AP can be performed by any of the STAs 111-114 of FIG. 1. The embodiment of the example method for association 500 performed by a STA when switching to a new AP shown in FIG. 5 is for illustration only. Other embodiments of the example method 500 for association performed by a STA when switching to a new AP could be used without departing from the scope of this disclosure.

As illustrated in FIG. 5, the method 500 for association performed by a STA when switching to a new AP begins at step 502, where a determination is made whether the STA wants to perform (Re)association. If the STA does not want to perform (Re)association, then at step 504 no action is taken. If the STA wants to perform (Re)association, then at step 506, the STA can transmit a (Re)association message to its current AP.

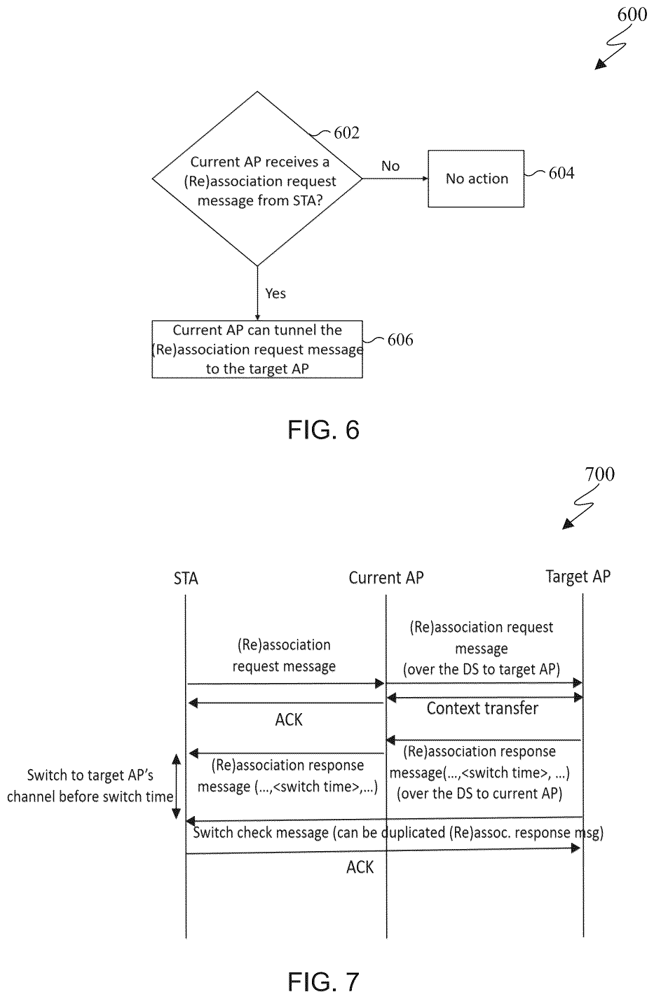

FIG. 6 illustrates an example method 600 for association performed by an AP when switching to a new AP according to embodiments of the present disclosure. For example, the method 600 for association performed by an AP when switching to a new AP can be performed by any of the APs 101, 103 of FIG. 1. The embodiment of the example method 600 for association performed by an AP when switching to a new AP shown in FIG. 6 is for illustration only. Other embodiments of the example method 600 for association performed by an AP when switching to a new AP could be used without departing from the scope of this disclosure.

As illustrated in FIG. 6, the method 600 for association performed by an AP when switching to a new AP begins at step 602, where a determination is made whether the current AP receives a (Re)association request message from the STA. If the current AP does not receive a (Re)association request message from the STA, then at step 604 no action is taken. If the current AP receives a (Re)association request message from the STA, then at step 606, the current AP can tunnel the (Re)association message to the target AP.

FIG. 7 illustrates an example of an association procedure 700 when switching to a new AP according to embodiments of the present disclosure. For example, the association procedure 700 when switching to a new AP can be performed by any of the STAs 111-113 and any of the APs 101, 103 of FIG. 1. The embodiment of the association procedure 700 when switching to a new AP shown in FIG. 7 is for illustration only. Other embodiments of the association procedure 700 when switching to a new AP could be used without departing from the scope of this disclosure.

As illustrated in FIG. 7, a STA can transmit a (Re)association request message to the target AP via the current AP. The (Re)association request message can contain at least one or more of the information items as indicated in Table 1 herein.

Upon receiving the (Re)association request message, the current AP can generate an ACK message which can convey the reception of the (Re)association request message. Additionally, the ACK message can also convey the current AP's intent to tunnel the message to the target AP.

The current AP can tunnel the message to the target AP over the DS communication. When the target AP receives a (Re)association request message that is tunneled to it via the current AP, the target AP can process the request and generate a (Re)association response message. The response message can be tunneled to the current AP over the wired network (e.g., over the DS).

Upon receiving a response from the target AP, the current AP can also perform context transfer to the target AP. The context transfer can be a transfer of contexts related to block acknowledgement (BA), stream classification service (SCS), quality of service (QOS), target wake time (TWT) or its variants, serial number (SN), part number (PN), etc. Upon receiving the context transfer message from the current AP, the target AP can receive the context transfer and apply the context for the STA.

Upon receiving the response message from the target AP, the current AP can transmit the response message to the STA.

The (Re)association response message generated by the target AP can contain at least one or more of the information items as indicated in Table 2 herein.

When the STA receives the (Re)association response message via its current AP, the STA can switch to the target AP's channel at a time indicated in the (Re)association response message. The target AP can transmit a duplicate (Re)association response message to the STA after the STA has switched to the target AP's channel. Alternatively, the STA can transmit a notification message after switching.

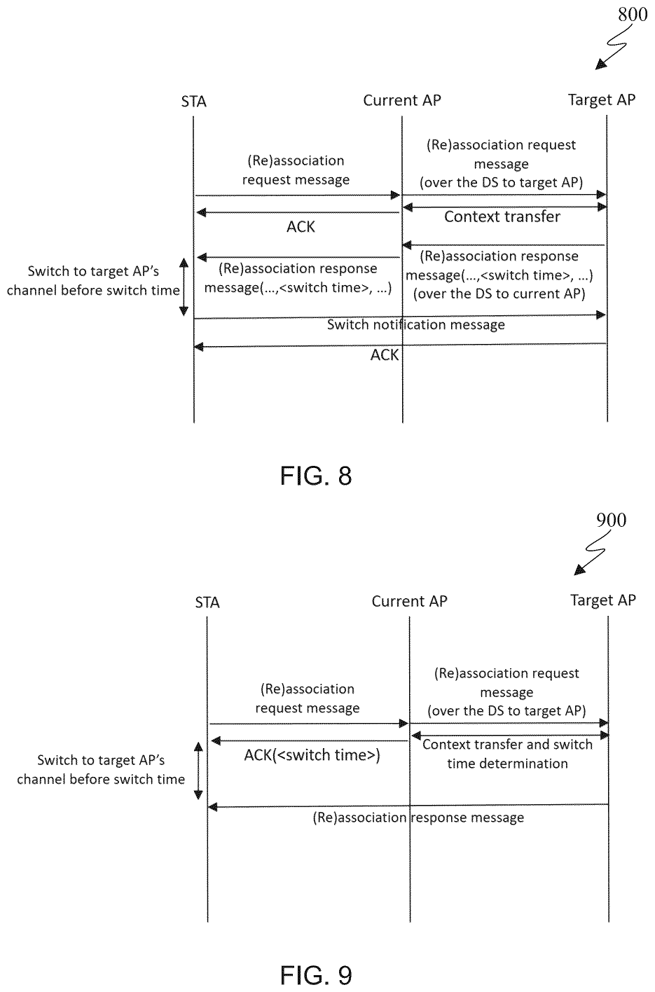

FIG. 8 illustrates another example of an association procedure 800 when switching to a new AP according to embodiments of the present disclosure. For example, the association procedure 800 when switching to a new AP can be performed by any of the STAs 111-113 and any of the APs 101, 103 of FIG. 1. The embodiment of the association procedure 800 when switching to a new AP shown in FIG. 8 is for illustration only. Other embodiments of the association procedure 800 when switching to a new AP could be used without departing from the scope of this disclosure.

As illustrated in FIG. 8, a STA can transmit a (Re)association request message to the target AP via the current AP. The (Re)association request message can contain at least one or more of the information items as indicated in Table 1 herein.

Upon receiving the (Re)association request message, the current AP can generate an ACK message which can convey the reception of the (Re)association request message. Additionally, the ACK message can also convey the current AP's intent to tunnel the message to the target AP.

The current AP can tunnel the message to the target AP over the DS communication. When the target AP receives a (Re)association request message that is tunneled to it via the current AP, the target AP can process the request and generate a (Re)association response message. The response message can be tunneled to the current AP over the wired network (e.g., over the DS).

Upon receiving a response from the target AP, the current AP can also perform context transfer to the target AP. The context transfer can be a transfer of contexts related to BA, SCS, QOS, TWT or its variants, SN, PN, etc. Upon receiving the context transfer message from the current AP, the target AP can receive the context transfer and apply the context for the STA.

Upon receiving the response message from the target AP, the current AP can transmit the response message to the STA.

The (Re)association response message generated by the target AP can contain at least one or more of the information items as indicated in Table 2 herein.

When the STA receives the (Re)association response message via its current AP, the STA can switch to the target AP's channel at a time indicated in the (Re)association response message. The STA can transmit a notification message after switching. The target AP can transmit an ACK message upon receiving the notification message.

FIG. 9 illustrates yet another example of an association procedure 900 when switching to a new AP according to embodiments of the present disclosure. For example, the association procedure 900 when switching to a new AP can be performed by any of the STAs 111-113 and any of the APs 101, 103 of FIG. 1. The embodiment of the association procedure 900 when switching to a new AP shown in FIG. 9 is for illustration only. Other embodiments of the association procedure 900 when switching to a new AP could be used without departing from the scope of this disclosure.

As illustrated in FIG. 9, a STA can transmit a (Re)association request message to the target AP via the current AP. The (Re)association request message can contain at least one or more of the information items as indicated in Table 1 herein.

Upon receiving the (Re)association request message, the current AP can generate an ACK message which can convey the reception of the (Re)association request message. Additionally, the ACK message can also convey the current AP's intent to tunnel the message to the target AP, and can contain information associated with a switching time that the STA can switch to the target AP's channel.

The current AP can tunnel the message to the target AP over the DS communication. The current AP can also perform context transfer to the target AP. The context transfer can be a transfer of contexts related to BA, SCS, QOS, TWT or its variants, SN, PN, etc. Upon receiving the context transfer message from the current AP, the target AP can receive the context transfer and apply the context for the STA.

When the target AP receives a (Re)association request message that is tunneled to it via the current AP, the target AP can process the request and generate a (Re)association response message. The (Re)association response message can be sent to the STA. The (Re)association response message generated by the target AP can contain at least one or more of the information items as indicated in Table 2 herein.

### 2. Assisted (Re)Association

According to some embodiments, the STA can have a weak connection to its current AP and may not be able to perform a tunneled (Re)association via its current AP. The STA can switch to the target AP's channel and perform a (Re)association with the target AP. When transmitting the (Re)association request message, the STA can request the target AP to perform the context transfer from the current AP. The target AP can pull the context from the current AP and send a confirmation message to the STA upon completion.

### 3. Capability Advertisement

According to one embodiment, an AP that can perform such a tunneled (Re)association procedure can advertise its capability in one or more frames that it transmits. For example, the AP can advertise its capability in a capability bit/flag in management frames such as beacons, probe response, etc. that can indicate the AP's capability.

According to one embodiment, a STA that can perform such a tunneled (Re)association procedure can advertise the capability in one or more frame that it transmits. For example, the STA can advertise its capability in a capability bit/flag in management frames such as (Re)association requests, etc.

It will be appreciated by those skilled in the art that the above embodiments can be applicable for multi-link operation as well and are not limited to single link.

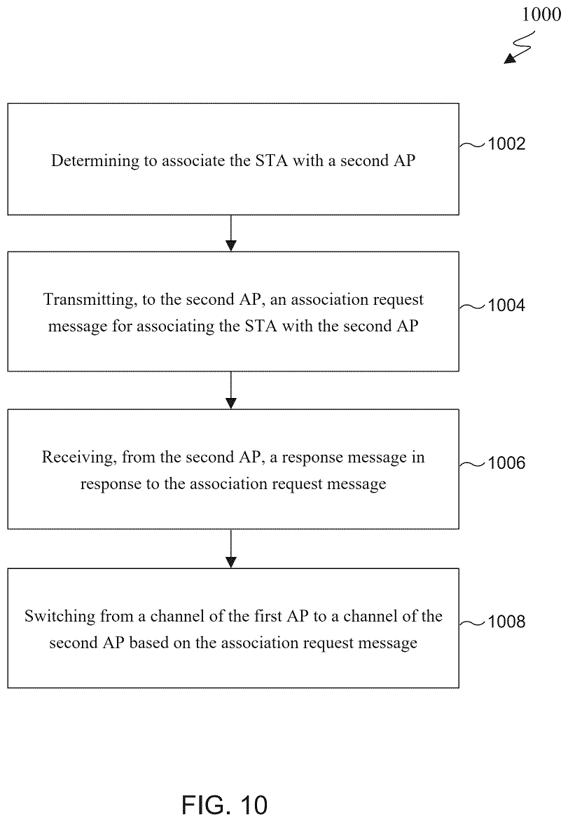

FIG. 10 illustrates an example method 1000 performed by a STA in a wireless communication system according to embodiments of the present disclosure. The method 1000 of FIG. 10 can be performed by any of the STAs 111-114 of FIG. 1, such as the STA 111 of FIG. 3. The method 1000 is for illustration only and other embodiments can be used without departing from the scope of the present disclosure.

As illustrated in FIG. 10, the method 1000 begins at step 1002, where the STA determines to associate with a second AP. At step 1004, the STA transmits, to the second AP, an association request message for associating the STA with the second AP. At step 1006, the STA receives, from the second AP, a response message in response to the association request message. At step 1008, the STA switches from a channel of the first AP to a channel of the second AP based on the association request message.

In some embodiments, the STA requests the second AP to perform a context transfer of data associated with the STA from the first AP.

In some embodiments, the STA transmits the association request message to the second AP via the first AP.

In some embodiments, the STA receives an acknowledgement message from the first AP, where the acknowledgement message indicates an intent of the first AP to transmit the association request message to the second AP.

In some embodiments, the association request message includes at least one of: information indicating an intended second AP; information associated with a legacy request message; information indicating that the STA is requesting the first AP to transmit the association request message to the second AP; information indicating that an acknowledgement message is needed in response to the association request message; information indicating that the STA can switch to the second AP after receipt of the acknowledgement message; information indicating that the STA can receive a duplicate association response message from the second AP after switching from the channel of the first AP to the channel of the second AP; and information indicating that the STA can transmit an indication message upon switching from the channel of the first AP to the channel of the second AP.

In some embodiments, the STA receives, from the first AP, a response message generated by the second AP. The response message includes at least one of: information indicating a time by which the second AP can expect the STA to be present on the channel of the second AP; information associated with a legacy response message; and information indicating completion of context transfer of data associated with the STA.

In some embodiments, the STA transmits an indication of support for an association procedure to the first AP or the second AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a station (STA) associated with a first access point (AP), the method comprising:
determining to associate the STA with a second AP;
transmitting, to the second AP, an association request message for associating the STA with the second AP;
receiving, from the second AP, a response message in response to the association request message; and
switching from a channel of the first AP to a channel of the second AP based on the association request message.

2. The method of claim 1, wherein transmitting the association request message includes requesting the second AP to perform a context transfer of data associated with the STA from the first AP.

3. The method of claim 1, wherein transmitting the association request message to the second AP comprises transmitting the association request message to the second AP via the first AP.

4. The method of claim 3, further comprising:
receiving an acknowledgement message from the first AP, wherein the acknowledgement message indicates an intent of the first AP to transmit the association request message to the second AP

5. The method of claim 3, wherein the association request message includes at least one of:
information indicating an intended second AP;
information associated with a legacy request message;
information indicating that the STA is requesting the first AP to transmit the association request message to the second AP;
information indicating that an acknowledgement message is needed in response to the association request message;
information indicating that the STA can switch to the second AP after receipt of the acknowledgement message;
information indicating that the STA can receive a duplicate association response message from the second AP after switching from the channel of the first AP to the channel of the second AP; and
information indicating that the STA can transmit an indication message upon switching from the channel of the first AP to the channel of the second AP.

6. The method of claim 3, wherein:
receiving the response message comprises receiving, from the first AP, a response message generated by the second AP; and
the response message includes at least one of:
information indicating a time by which the second AP can expect the STA to be present on the channel of the second AP;
information associated with a legacy response message; and
information indicating completion of context transfer of data associated with the STA.

7. The method of claim 3, further comprising:
transmitting an indication of support for an association procedure to the first AP or the second AP.

8. A second access point (AP), comprising:
a transceiver configured to:
receive, from a station (STA) associated with a first AP, an association request message for associating the STA with the second AP; and
transmit, to the STA, a response message in response to the association request message; and
a processor operably coupled with the transceiver, the processor configured to:
determine a channel for communication with the STA.

9. The second AP of claim 8, wherein to receive the association request message, the transceiver is further configured to receive a request to perform a context transfer of data associated with the STA from the first AP.

10. The second AP of claim 8, wherein to receive the association request message, the transceiver is further configured to receive the association request message via the first AP.

11. The second AP of claim 10, wherein the association request message includes at least one of:
information indicating an intended second AP;
information associated with a legacy request message;
information indicating that the STA is requesting the first AP to transmit the association request message to the second AP;
information indicating that an acknowledgement message is needed in response to the association request message;
information indicating that the STA can switch to the second AP after receipt of the acknowledgement message;
information indicating that the STA can receive a duplicate association response message from the second AP after switching from the channel of the first AP to the channel of the second AP; and
information indicating that the STA can transmit an indication message upon switching from a channel of the first AP to a channel of the second AP.

12. The second AP of claim 10, wherein the response message includes at least one of:
information indicating a time by which the second AP can expect the STA to be present on the channel of the second AP;
information associated with a legacy response message; and
information indicating completion of context transfer of data associated with the STA.

13. The second AP of claim 10, wherein the transceiver is further configured to receive an indication of support for an association procedure from the STA.

14. A station (STA) associated with a first access point (AP), the STA comprising:
a processor configured to:
determine to associate the STA with a second AP; and
a transceiver operably coupled with the processor, the transceiver configured to:
transmit, to the second AP, an association request message for associating the STA with the second AP; and
receive, from the second AP, a response message in response to the association request message,
wherein the processor is further configured to switch from a channel of the first AP to a channel of the second AP based on the association request message.

15. The STA of claim 14, wherein to transmit the association request message, the transceiver is further configured to transmit a request to the second AP to perform a context transfer of data associated with the STA from the first AP.

16. The STA of claim 14, wherein to transmit the association request message, the transceiver is further configured to transmit the association request message to the second AP via the first AP.

17. The STA of claim 16, wherein the transceiver is further configured to receive an acknowledgement message from the first AP, wherein the acknowledgement message indicates an intent of the first AP to transmit the association request message to the second AP.

18. The STA of claim 16, wherein the association request message includes at least one of:
information indicating an intended second AP;
information associated with a legacy request message;
information indicating that the STA is requesting the first AP to transmit the association request message to the second AP;
information indicating that an acknowledgement message is needed in response to the association request message;
information indicating that the STA can switch to the second AP after receipt of the acknowledgement message;
information indicating that the STA can receive a duplicate association response message from the second AP after switching from the channel of the first AP to the channel of the second AP; and
information indicating that the STA can transmit an indication message upon switching from the channel of the first AP to the channel of the second AP.

19. The STA of claim 16, wherein:
to receive the response message, the transceiver is further configured to receive, from the first AP, a response message generated by the second AP; and
the response message includes at least one of:
information indicating a time by which the second AP can expect the STA to be present on the channel of the second AP;
information associated with a legacy response message; and
information indicating completion of context transfer of data associated with the STA.

16. TA of claim 16, wherein the transceiver is further configured to transmit an indication of support for an association procedure to the first AP or the second AP.
